(19) United States
(12) Patent Application Publication
(10) Pub. No.: US 2006/0075025 A1
(43) Pub. Date: Apr. 6, 2006

(54) System and method for data tracking and management

(76) Inventors: David Cheng, Irvine, CA (US); Vivien Fung, Santa Ana, CA (US); Andrew Padilla, Albuquerque, NM (US)

Correspondence Address: PAUL, HASTINGS, JANOFSKY & WALKER LLP, P.O. BOX 919092, SAN DIEGO, CA, 92191-9092, US

(21) Appl. No.: 10/538,439

(22) PCT Filed: Jan. 21, 2003
(86) PCT No.: PCT/US03/01853

§ 371 Date: Jun. 10, 2005

Related U.S. Application Data
(60) Provisional application No. 60/349,914, filed on Jan. 18, 2002.

(51) Int. Cl. G06F 15/16

(52) U.S. Cl. 709/206

(57) ABSTRACT

In one embodiment of the present invention's a system for tracking and managing data over a computer network including a plurality of application computers each operating a computer software application program is provided, comprising a key master (106, 108); a system startup module (100) connected to the key master (106, 108); a gatekeeper (102) connected to the system startup module (100); as task manager (122, 124, 126, 128's 130) connected to the key master (106, 108) and the gatekeeper (102); a central database (112, 114, 116) connected to the gatekeeper (102); a plurality of agents (132, 134, 136, 138, 140) connected to the task manager; a plurality of sub-agents (142, 144, 146, 148, 150) independently connected to the plurality of agents (132, 134, 136, 138, 140) and the plurality of application computers (152, 154,156, 158, 160); and an alert dispatcher (104) connected to the system startup module (100) and the gatekeeper (102).

### RELATED APPLICATION

The present application claims a right of priority under 35 U.S.C. §119 to U.S. provisional patent application entitled “INFORMATION TRACKING SYSTEM,” filed Jan. 18, 2002 and having Ser. No. 60/349,914, the disclosure of which application is hereby incorporated by reference.

### BACKGROUND OF THE INVENTION

1. Field of the Invention

The present invention relates to systems and methods for tracking and managing the flow of data in a computer network.

2. Description of Related Art

The growth in e-business, along with trends in mergers and acquisitions, has introduced new challenges for businesses. As organizations' networks of applications, business units and users become more complex and fragmented, better tools are needed to ensure that the data is secure, accurate, and readily accessible. There is a need to ensure smooth collaborations with new enterprise and e-business applications. In summary, in addition to retaining investments in legacy systems, there are also growing needs to address information security, privacy and to ensure end-to-end data transmission integrity across an enterprise by providing insight to the health and performance of the enterprise.

Currently, a typical enterprise network is built around a large enterprise solution wedded to one or more legacy systems. While conventional enterprise application integration and system network monitors perform an adequate job of tracking and managing data within their own system, these networks typically are unable to track data flow outside their system. Many times, however, a complete business process will pass data outside of the enterprise solution to a legacy system.

To get a full visualization of information movement over a network, conventional data tracking systems collected data on information activities from various audit trails such as log files and event files. Typical systems then required manually analyzing the data and producing a subsequent report. Conventional systems are also restricted to using pre-defined rules in data movement to detect possible internal breaches. It is desirable, therefore, to track the data flow throughout the complete business process across the entire enterprise. It is further desirable to provide a data tracking system that can ensure complete end-to-end data integrity across multiple platforms.

### BRIEF SUMMARY OF THE INVENTION

In one embodiment of the present invention, a system for tracking and managing data over a computer network including a plurality of application computers each operating a computer software application program is provided, comprising a key master; a system startup module connected to the key master; a gatekeeper connected to the system startup module; a task manager connected to the key master and the gatekeeper; a central database connected to the gatekeeper; a plurality of agents connected to the task manager; a plurality of sub-agents independently connected to the plurality of agents and the plurality of application computers; and an alert dispatcher connected to the system startup module and the gatekeeper.

In this embodiment, the alert dispatcher provides an alert notification comprising an email message, an electronic instant message, and/or a paging message. In this embodiment, the system uses a Linux operating system and the central database comprises a plurality of independent databases.

In another embodiment of the present invention, a method for tracking and managing a message over a computer network including a plurality of application computers each operating an computer software application program is provided, comprising the steps of monitoring the message at a lowest common format; comparing content of the message to a validator key; extracting a message key if the content of the message matches the validator key; assembling the message according to one or more predetermined rules; queuing the message; retrieving the message; and storing the message.

In this embodiment, the method further comprises the step of alerting an operator with an alert notification of a shutdown of the one of the plurality of application computers. In this embodiment, the alert notification comprises an email message, an electronic instant message, and/or a paging message.

In this embodiment, the method further comprises the steps of retrieving the message; and viewing the message. In one embodiment, the lowest common format comprises TCP/IP, FTP, or SNA.

In a further embodiment, a method for tracking and managing a message over a computer network including a plurality of application computers each operating a computer software application program is provided, comprising the steps of monitoring content of the message with a sub-agent; comparing the content of the message to a validator key with the sub-agent; extracting a message key if the content of the message matches the validator key with an agent; assembling the message based on one or more predetermined rules; queuing the message; retrieving the message with a task manager; and storing the message in a central database.

In this embodiment, the method further comprises the step of alerting an operator with an alert notification of a shutdown of the one of the plurality of application computers. In this embodiment, the alert comprises an email message, an electronic instant message, and/or a paging message.

In an embodiment, the central database comprises a plurality of independent databases. In an embodiment, the method further comprises the steps of retrieving and analyzing the message. In one embodiment, the lowest common format comprises TCP/IP, FTP, or SNA.

### BRIEF DESCRIPTION OF THE DRAWINGS

FIG. 1 shows a block diagram of the data tracking and management system in an embodiment of the present invention.

FIG. 2 shows a hardware configuration of the data tracking and management system in an embodiment of the system.

FIG. 3 shows a communications protocol of the data tracking and management system in an embodiment of the invention.

FIG. 4 shows a communications protocol between a Task Manager and a Gatekeeper of the data tracking and management system in an embodiment of the invention.

FIG. 5 shows a communications protocol between a Key Master and a Gatekeeper of the data tracking and management system in an embodiment of the invention.

FIG. 6 shows a communications protocol between an Alert Dispatcher and a Gatekeeper of the data tracking and management system in an embodiment of the invention.

FIG. 7 shows a communications protocol between an Agent and a Sub-Agent of the data tracking and management system in an embodiment of the invention.

FIG. 8 shows a diagram illustration a shutdown procedure for a Task Manager of the data tracking and management system in an embodiment of the invention.

FIG. 9 shows a diagram illustrating a shutdown procedure for a plurality of Task Managers of the data tracking and management system in an embodiment of the present invention.

FIG. 10 shows a diagram illustrating a shutdown procedure for a Key Master of the data tracking and management system in an embodiment of the invention.

FIG. 11 shows a diagram illustrating a shutdown procedure for a Gatekeeper in an embodiment of the invention.

FIG. 12 shows a diagram illustrating a shutdown procedure for an Alert Dispatcher in an embodiment of the invention.

### DETAILED DESCRIPTION OF THE INVENTION

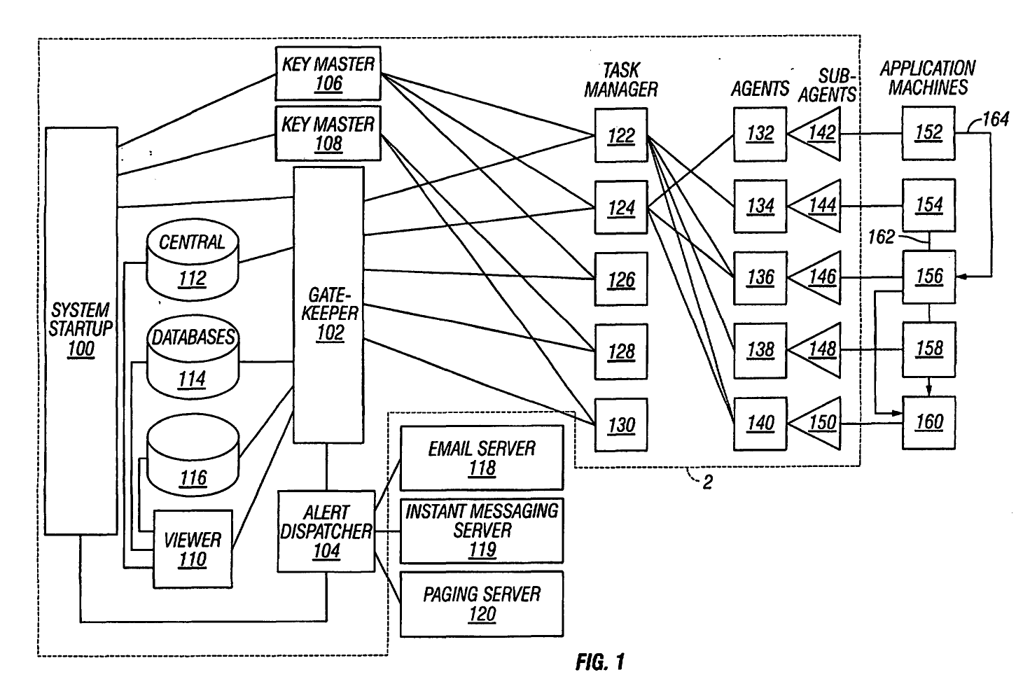

FIG. 1 shows a block diagram of the Data Tracking and Management System in an embodiment of the present invention. In this embodiment shown in FIG. 1, the Data Tracking and Management System 2 comprises a System Startup Module 100, a Gatekeeper 102, an Alert Dispatcher 104, Key Masters 106 and 108, a Viewer 110, Central Database 112, 114 and 116, Task Managers 122, 124, 126, 128 and 130, Agents 132, 134, 136, 138 and 140, and Sub-Agents 142, 144, 146, 148 and 150. In this embodiment, the System Startup Module 100 is connected to the Gatekeeper 102, the Alert Dispatcher 104, and the Key Masters 106 and 108. The Gatekeeper 102 and the Viewer 110 are further connected to the Central Databases 112, 114 and 116. The Gatekeeper 102 is also connected to Alert Dispatcher 104. The Key Masters 106 and 108 are further connected to the Task Managers 122, 124, 126, 128 and 136. In this embodiment, the Key Master 106 is connected to the Task Managers 122, 124, and 126 and the Key Master 108 is connected to the Task Managers 128 and 130.

In this embodiment, the Task Manager 122 is connected to the Agents 134, 136, 138 and 140, while the Task Manager 124 is connected to the Agents 132, 136 and 140. The Task Managers 126, 128, and 130 can be connected to the one or more Agents 132, 134, 136, 138 and 140, but for clarity sake are not shown in the FIG. 1. It is also noted that in various embodiments, not every Task Manager is logically connected to every Agent, and that two or more Task Managers can be logically connected to the same Agent.

Each of the Agents 132, 134, 136, 138 and 140 are also connected to each of the Sub-Agents 142, 144, 146, 148 and 150, respectively. I another embodiment, more than one of the Agents 132, 134, 136, 138 and 140 can be connected to one of the Sub-Agents 142, 144, 146, 148. Each of the Sub-Agents 142, 144, 146, 148 and 150, is further connected to an application machine 152, 154, 156, 158 and 160, respectively.

In this embodiment, each of the connections described above can comprise a physical connection such as a cable using an Ethernet protocol. Also, the connection can further comprise an Ethernet switch and router if the two endpoints of the connection reside on different physical computers. In another embodiment, the connections can comprise a virtual connection using techniques such as system calls or inter-process communications if the two endpoints of the connection reside on the same physical machine. Alternatively, if the two endpoints of a connection reside on the same machine, the virtual connection can use an Ethernet protocol along with a conventional loopback device.

In this embodiment, the System Startup Module 100 comprises a script or program that initiates other components of the system, including the Gatekeeper 102, the Alert Dispatcher 104, and the Key Masters 106 and 108. In one embodiment, the Gatekeeper 102, the Alert Dispatcher 104, and the System Startup Module 100 all reside on a single computer using a UNIX operating system. In such an embodiment, the System Startup Module 100 initiates the Gatekeeper 102 and the Alert Dispatcher 104 using a conventional system call such as “exec”, “system”, or “fork”, which is a method for one process to start another. In this embodiment, the Key Masters 106 and 108 reside on other computers and can be initiated using a remote invocation, such as the use of “rsh”, “remsh” or “rexec” on a computer using UNIX, or the use of remote invocation methods on a computer using a Java Virtual Machine. In alternative embodiments, one or more of the Key Masters can reside on the same machine as the System Startup Module 100. In this case, the one or more Key Masters can be launched with a single system call. In other embodiments, the Gatekeeper 102 and/or the Alert Dispatcher 104 can reside on separate computers than the System Startup Module 100 and can be initiated using a remote invocation. Additionally, a remote invocation can be used even if the components reside on the same computer by applying the invocation over a loopback device.

In an embodiment, the Gatekeeper 102 services requests and responses to and from one or more of the Central Databases 112, 114 and 116, serving as a buffer between the Central Databases 112, 114 and 116 and the various Task Managers 122, 124, 126, 128 and 130. In some embodiments, the Gatekeeper 102 also serves as a buffer between the Central Databases 112, 114 and 116 and the Alert Dispatcher 104. In operation, the Gatekeeper 102 pools database transactions to more efficiently transfer data to and from the Central Databases 112, 114 and 116. In addition, the Gatekeeper 102 functions as an intermediary by which the Viewer 110 configures the Task Managers 122, 124, 126, 128 and 130 and the Agents 132, 134, 136, 138 and 140 by delivering configuration parameters to the Task Managers 122, 124, 126, 128 and 130. Through the responsible Key Master, the online status of a Task Manager 122, 124, 126, 128 and 130 can be altered by relaunching or terminating that Task Manager as specified by the Viewer 110. For example, the Viewer 110 can request termination of Task Manager 128 by sending a request to the Gatekeeper 102, which then issues a request to the responsible Key Master 108. Finally, the Key Master 108 terminates the Task Manager 128. The Gatekeeper 102 can further update the Central Databases 112, 114 and 116 regarding status or errors that occur during these configuration or alerting processes.

In an embodiment, the Alert Dispatcher 104 queries or polls one or more Central Databases 112, 114 and 116 at predetermined periodic intervals for alert situations. In an alternate embodiment, the Central Databases 112, 114 and 116 can directly notify the Alert Dispatcher 104. In other embodiments, for the polling transaction or the notification transaction described above, the Gatekeeper 102 can be employed as an intermediary. If the Alert Dispatcher 104 detects an alert situation or is notified of an alert situation, it sends out alerts to one or more relevant administrators using one or more predefined alert methods. As shown in FIG. 1, these alert methods can include email 118, instant messaging 119 and/or paging 120.

In one embodiment, the nature of the alert determines the alert method and relevant administrators. For example, a system administrator is paged in the event that a system failure is detected. In another example, an application user is emailed when an error occurs in that specific application, but not when an alert situation develops related to another application. In another embodiment, the lack of an alert situation constitutes an alert situation, so an administrator is periodically notified that the system is operating properly. In another embodiment, the Alert Dispatcher 104 is configured to defer non-critical alert situations until an appropriate time, such as during regular business hours.

In one embodiment, the Alert Dispatcher 104 queries or polls the Central Databases 112, 114 and 116 for various data based on the configuration parameters, and then determines whether an alert is warranted. For instance, the Alert Dispatcher 104 can include a parameter for a maximum connection timeout. If a connection is inoperable for at least that time interval, the Alert Dispatcher 104 provides an alert to an appropriate party.

The Key Masters 106 and 108 manage the online state of one or more of the Task Managers 122, 124, 126, 128 and 130. The Key Masters 106 and 108 are also responsible for the launching of each Task Manager 122, 124, 126, 128 and 130 it manages and the relaunching of any Task Manager 122, 124, 126, 128 and 130 it manages that may have terminated. In the embodiment shown in FIG. 1, the Key Master 106 is responsible for managing the Task Managers 122, 124, 126 and the Key Master 108 is responsible for managing the Task Managers 128 and 130. When the online state of a Task Manager 122, 124, 126, 128 and 130 needs to be changed, the responsible Key Master 106 and 108 is notified by the Gatekeeper 102 of the required change. If a particular Task Manager 106 and 108 terminates abnormally, the responsible Key Master 122, 124, 126, 128 and 130 detects the online status change and relaunches that Task Manager. If a particular Task Manager 122, 124, 126, 128 and 130 is to be terminated, the Key Master 106 and 108 terminates the Task Manager upon notification by the Gatekeeper 102.

In one example, a Key Master 106 and 108 operates on the same computer as the certain Task Managers 122, 124, 126, 128 and 130. Hence, the Key Master 106 and 108 can launch or relaunch the Task Manager 122, 124, 126, 128 and 130 using a system execute call, such as the use of “fork”. The Key Master 106 and 108 can terminate a Task Manager 122, 124, 126, 128 and 130 using a system termination command such as “kill”. In another embodiment, two or more of the Task Managers 122, 124, 126, 128 and 130 reside on different machines and a remote invocation can be used to launch or terminate the Task Managers 122, 124, 126, 128 and 130.

In this embodiment, the Task Managers 122, 124, 126, 128 and 130 track and monitor the data flow from a source computer software application to a destination computer software application. This data flow is collectively referred to herein as a “task”. Each of the Task Managers 122, 124, 126, 128 and 130 is managed by a Key Master 106 and 108, which launches, or terminates the Task Manager as needed. The Task Managers 122, 124, 126, 128 and 130 receive message keys, described below, from the Agents 132, 134, 136, 138 and 140 related to the task for which the Task Manager is responsible. For the embodiment shown in FIG. 1, the Task Manager 122 monitors a Task 162 associated with Agents 134, 136, 138 and 140. Similarly, the Task Manager 124 monitors a Task 164 associated with Agents 132, 136 and 140. The Task Managers 122, 124, 126, 128 and 130 also gather communication events, such as retry counts, timeouts, and downed connections. In addition, the Task Managers 122, 124, 126, 128 and 130 can also determine whether an alert situation has occurred, and to whom and how an alert should be delivered. The Task Managers 122, 124, 126, 128 and 130 report alert situations and message keys to the Gatekeeper 102, which then delivers the status information, alert situations and message keys to the appropriate Central Databases 112, 114 and 116. Depending on the specific organization of the Central Databases 112, 114 and 116 are organized, information pertaining to a specific task can reside on one or more just some of the Central Databases 112, 114 and 116. Therefore, the Gatekeeper 102 may not deliver data to all the Central Databases 112, 114 and 116.

In this embodiment, the Viewer 110 comprises a user interface for an operator to view the flow of configuration, monitoring and tracking data for various tasks to and from the Central Databases 112, 114 and 116 for presentation via the Gatekeeper 102. More specifically, the Viewer 110 allows an operator to monitor the status of and issue commands through the Gatekeeper 102 to change the online status and configuration of the Gatekeeper 102, the Key Masters 106 and 108, the Task Managers 122, 124, 126, 128 and 130, the Alert Dispatcher 104, and the Agents 132, 134, 136, 138 and 140. In one example, the Viewer 110 connects to the Central Databases 112, 114 and 116 via a Java Application Server based on the Java 2 Platform, Enterprise Edition (J2EE).

In this embodiment, the Central Databases 112, 114 and 116 contain status information, alerts and message keys, which originate from the Agents 132, 134, 136, 138 and 140 and the Gatekeeper 102. In an embodiment 112, 114 and 116, the Central Databases 112, 114 and 116 comprise status information, alerts and message keys pertaining to specific tasks. In another embodiment, each of the Central Database 112, 114 and 116 comprise differ classes of information. For example, the Central Database 112 can comprise status information, the Central Database 114 can comprise alerts, and the Central Database 116 can comprise message keys pertaining to specific tasks. In this example, for an alert situation, the Alert Dispatcher 104 need poll only the Central Database 114 which comprises alerts.

The Agents 132, 134, 136, 138 and 140 receive messages and status information from the Sub-Agent 142, 144, 146, 148 and 150 for which that Agent is responsible. In the embodiment shown in FIG. 1, the Agent 132 is responsible for the Sub-Agent 142, from which it receives messages and status information. Likewise, each of the Agents 134, 136, 138 and 140 are responsible for and receive messages and status information from each of the Sub-Agents 144, 146, 148 and 150, respectively. Upon receiving a message from a Sub-Agent, the responsible Agent extracts a message key from the message. In one embodiment of the invention, a standard expressions are used to extract the message key. In this usage, a standard expression converts a message string into another string in a different language. The message key can incorporate information such as the type of message (e.g., medical record or patient), the Agent performing the extraction, and important message fields such as medical record number or patient ID. In one embodiment, a queue is used to buffer each connection between an Agent and a Task Manager. As shown in FIG. 1, a queue is used to buffer the connection between the Task Manager 122 and the Agent 136, and the Task Manager 124 and the Agent 140. This queue can reside either with the Agent or the Task Manager. As each Agent receives message keys or status information for a particular Task Manager, that message key or status information is placed into the queue. When the Task Manager is ready to process the information it removes it from the queue, which helps to optimize communication performance.

It should be noted that the Task Managers need only to be connected to the Agents that monitor information relevant to that specific Task Manager's task. For example, in the embodiment shown in FIG. 1, there is not a connection between the Agent 132 and the Task Manager 122 because the Task 162 does not require information processed by the Agent 132. In addition, each Agent can service multiple Task Managers, such as shown in FIG. 1, where the Agent 136 is servicing both of the Task Managers 122 and 124. In an embodiment, the Agents 132, 134, 136, 138 and 140 can also decrypt known encrypted messages prior to key extraction.

In this embodiment, the Sub-Agents 142, 144, 146, 148 and 150 are deployed strategically close to the application machines 152, 154, 156, 158 and 160 that are operating applications to be monitored by the Data Tracking and Monitoring System 2. In this context, strategically close can mean either close in the physical sense (e.g., in the same room) or in a network sense (e.g., residing on the same subnetwork in the case of an Ethernet network).

The strategically close concept facilitates easier access to the data to be monitored. For example, as shown in the embodiment of FIG. 1, each of the Sub-Agents 142, 144, 146, 148 and 150 are shown connected to each of the application machines 152, 154, 156, 158 and 160, respectively. In various embodiments, the Sub-Agents 142, 144, 146, 148 and 150 assemble messages from a target source application machine 152, 154, 156, 158 and 160 by methods such as packet sniffing, which can be performed by tapping into an appropriate switch or router; file polling, which can be performed by a remote invocation to copy or view select files on a target application machine; Application Program Interface (API) collection of a specific message, which is a predefined API for extracting the desired message; or other protocols that have message collection features such as DECNET and SNA. Further, the Sub-Agents 142, 144, 146, 148 and 150 monitor the messages at the lowest common format such as, for example, Transmission Control Protocol/Internet Protocol (TCP/IP), File Transfer Protocol/File Transfer Program (FTP), or Systems Network Architecture (SNA). Generally, the Sub-Agents 142, 144, 146, 148 and 150 remain non-intrusive with regard to process, disk space, memory and other resources on the target application machines 152, 154, 156, 158 and 160. In addition, the Sub-Agents 142, 144, 146, 148 and 150 are each configured with a message validator, which indicates whether a message is relevant to that Sub-Agent's operation. In one embodiment, this function is accomplished with a regular expression filter. If the message matches a regular expression then it is classified as a pertinent message, and if the message fails to match a regular expression then it is classified as not pertinent to that Sub-Agent. As the Sub-Agents 142, 144, 146, 148 and 150 collect pertinent messages, the messages are delivered to the responsible Agent. For example, the Sub-Agents 142, 144, 146, 148 and 150 deliver messages to the Agents 132, 134, 136, 138 and 140, respectively.

The Data Tracking and Management System 2 as shown in FIG. 1 operates as follows. In this example, a Task 164 is being tracked as it is performed by computer application software on the application machines 152, 156 and 160. Sub-Agent 142, 146 and 150 monitor each of the application machines 152, 156 and 160, respectively, and retrieve all messages having content that matches a validator key for that specific Sub-Agent 142, 146 and 150. Those messages that match the validator key are then processed, and the message keys are extracted by the responsible Agent 132, 136 and 140, respectively. After the message keys extracted, the messages are placed in queues for the responsible Task Manager, which in this case is Task Manager 124. When ready, the Task Manager 124 retrieves the message keys from the queue and delivers the messages to the Gatekeeper 102. Finally, the Gatekeeper 102 sends the data from the messages to the appropriate Central Databases 112, 114 and 116. This data can then be retrieved by the Gatekeeper 102 at a later time, and processed at the Viewer 110 for an operator to analyze.

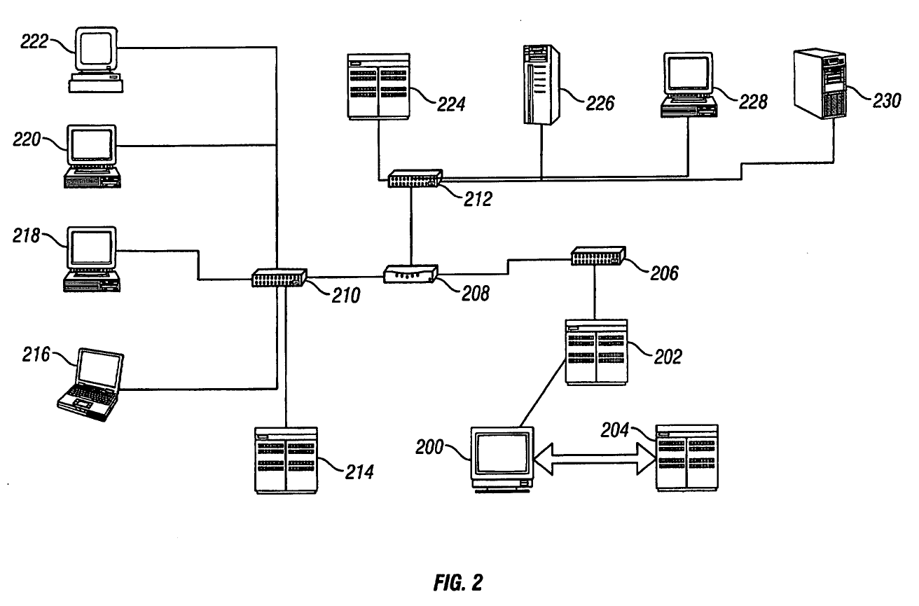

FIG. 2 shows a hardware configuration of the Data Tracking and Management System in an embodiment of the system. As shown in FIG. 2, a monitoring station 200 is connected to one or more central database servers 204. The central server 202 is also connected to the one or more central database servers 204, and to a network through switch 206. Switch 206 is connected to a central router 208 for the network, which in turn is connected to other switches 210 and 212. In this embodiment, the higher level services are isolated by switch 206, thus providing an organizational advantage because all of the data is centralized in one location on the network.

In an embodiment, each of the switches 210 and 212 service a region such as a subnetwork on an Ethernet network. Each such region contains an Agent server 214 and 224 and one or more computers using the applications to be monitored. In the embodiment shown in FIG. 2, the region serviced by switch 210 includes an Agent server 214 and four computers of various types, such as a laptop 216, desktop computers 218 and 220 and a workstation 222. Similarly, the region serviced by switch 212 includes an Agent server 224 and three computers of various types, such as a server 226, a desktop computer 228, and a microcomputer 230.

In this embodiment, each of the Sub-Agents reside on the same computer as the responsible Agent on the Agent servers 214 and 224. Also, the Task Managers, the Gatekeeper, the Alert Dispatcher, the System Startup Module and Key Masters reside on a central server 202. The Viewer resides the monitoring station 200. Furthermore, switches 210 and 212 are configured to allow the Sub-Agents on the Agent Servers 214 and 224 to monitor packets being transmitted through the switches 206 and 212.

In one example of the data tracking and management system, the typical hardware requirements for the Key Master(s), the Gatekeeper, the Alert Dispatcher, and the Task Manager(s) include a computer with a Pentium 4 processor operating at a 1 GHz speed, 512 Mb memory, 2×18 Gb SCSI II Ultra Wide RAID hard-drive using a Linux 6.2 operating system produced by Red Hat, Inc. In this example, the typical hardware requirements for the Agent(s) include a computer with a Pentium 4 processor operating at a 1 GHz speed, 256 Mb memory, 18 Gb SCSI II Ultra Wide RAID hard-drive using a Linux 6.2 operating system. Further in this example, the typical hardware requirements for the Central Database(s) include a computer that uses a Solid Technologies Embedded Engine and using a Linux 6.2 operating system.

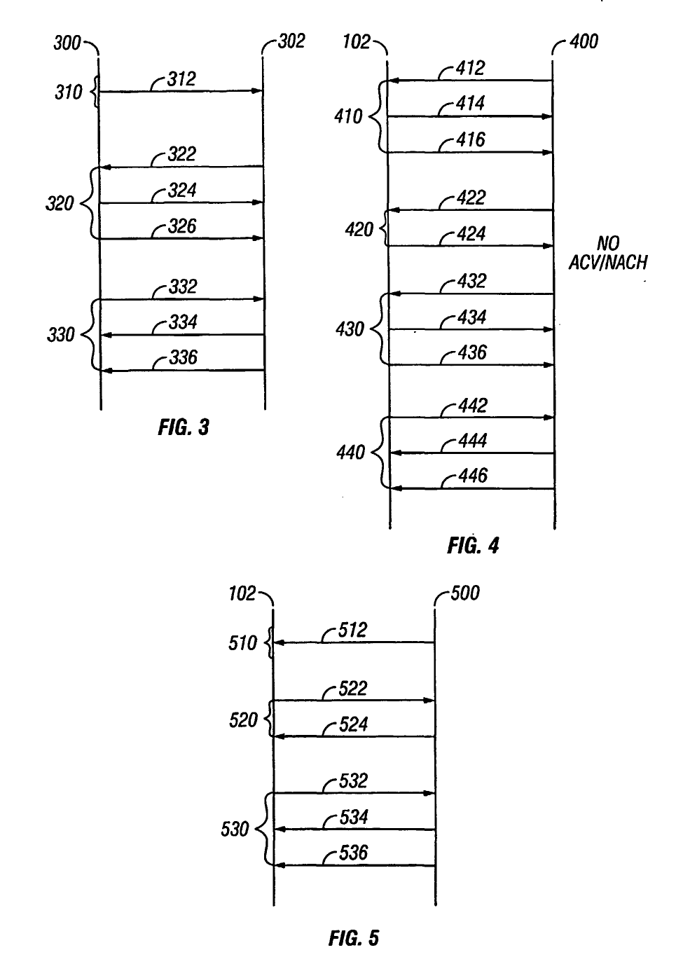

FIGS. 3-8 illustrate various message protocols between the various components of the system. While various messaging schemes and various message languages can be used, in the embodiment shown in FIGS. 3-8, messages between components conform to the Extended Markup Language (XML). Furthermore, to identify components with multiple instances, an identification (ID) number is to assigned to each Task Manager, Key Master, Agent, and Sub-Agent. In addition, while many of the examples illustrate a single Task Manager, Key Master, Agent or Sub-Agent, the transaction is not restricted to a single component or a specific component in other embodiments.

FIG. 3 shows a communications protocol of the Data Tracking and Management System in an embodiment of the invention. As shown in FIG. 3, for protocol 310, a Task Manager 300 configures an Agent 302 by issuing a message 312. The message 312 can comprise various configuration parameters for the Agent 302, such as an IP address and a port number to perform sniffing operations and use the regular expression validator. For protocol 320, the Agent 302 delivers a status code or a message key using a message 322. Upon successful queuing of the information, the Task Manager 300 responds with an acknowledgement (ACK) 324. If the information fails to queue, the Task Manager 300 responds with a negative acknowledgement (NACK) 326, at which point, the Agent 302 can retransmit the message 322.

For protocol 330, the Task Manager 300 can shutdown the Agent 302 by issuing a message 332. Upon successful interpretation of the message 332, the Agent 302 responds with an ACK 334, otherwise the Agent 302 responds with a NACK 336. Upon receiving a NACK 336, the Task Manager 300 can retry the shutdown procedure.

FIG. 4 shows a communications protocol between a Task Manager and a Gatekeeper of the Data Tracking and Management System in an embodiment of the invention. For protocol 410, the Task Manager 400 notifies the Gatekeeper of the identity of its responsible Key Master, using a message 412. The message 412 comprises an identification (ID) number for the Task Manager 400 and an ID number of its responsible Key Master. Upon successful interpretation of the message, the Gatekeeper 102 responds with an ACK 414, otherwise the Gatekeeper 102 responds with a NACK 416. Upon receiving a NACK 416, the Task Manager 400 can retransmit the message 412.

For protocol 420, the Task Manager 400 is configured by submitting a request message 422, which comprises the ID number of the Task Manager 400 making the request. The Gatekeeper 102 responds with a configuration message 424, which comprises various configuration parameters of the Task Manager 400, and any Agents or Sub-Agents it needs to communicate with along with the Agents and Sub-Agents configuration information.

For protocol 430, the Task Manager 400 delivers status information or a message key to the Gatekeeper using a message 432. The message 432 comprises the status information or message key and can further comprise administrative information, such as the ID of the originating Agent, the ID of the Task Manager 400 and/or a time stamp. Upon successful processing of the message, the Gatekeeper 102 responds with an ACK 434, otherwise the Gatekeeper 102 responds with a NACK 436. Upon receiving a NACK 436, the Task Manager 400 can retransmit the message 412.

For protocol 440, the Gatekeeper 102 identifies a Task Manager 400 to remove its queue when shutting down by issuing a message 442. Upon successful processing of the message 442, the Task Manager 400 responds with an ACK 444, otherwise the Task Manager 400 responds with a NACK 446. Upon receiving a NACK 446, the Gatekeeper 102 can retransmit message 442.

FIG. 5 shows a communications protocol between a Key Master and a Gatekeeper of the Data Tracking and Management System in an embodiment of the invention. For protocol 510, a Key Master 500 notifies the Gatekeeper 102 that it is ready to start using a message 512. The Gatekeeper 102 responds with a message 514 comprising the ID numbers of the Task Manager 400 that is assigned to the Key Master 500. Upon receiving the response, the Key Master 500 relaunches any Task Manager 400 that is not online.

For protocol 520, the Gatekeeper 102 instructs the Key Master 500 to shutdown the Task Manager 400 by issuing a message 522, which comprises the ID number of the Task Manager 400 to be shutdown. Upon successful processing of the message 522, the Key Master 500 issues a shutdown request to the Task Manager 400 and responds with a message 524, which comprises the ID numbers and responses of the Task Manager 400 to the requests of the Key Master 500. Upon receipt of the message 524, the Gatekeeper 102 can elect to request a shutdown of the unresponsive Task Manager 400. For example, if the message 522 instructs the Key Master 500 to shutdown Task Manager 400 with ID 1,2, and 4, the Task Manager 400 with ID 1 and 2 may shutdown, but the Task Manager 400 with ID 4 may have responded to the Key Master 500 with a NACK. The response message 524 would comprise the following associated information: ID 1 reports ACK, ID 2 reports ACK, ID 4 reports NACK. Upon receipt of the message 524, the Gatekeeper 102 can transmit another message 522 with a request to shut down the Task Manager 400 with ID 4.

For protocol 530, the Gatekeeper 102 requests the Key Master 500 shutdown using a message 532, which can comprise the ID number of the Key Master 500 to be shutdown. Upon successful processing of the message, the Key Master 500 respond with an ACK 534 just prior to shutdown. If unsuccessful, the Key Master 500 responds with a NACK 536, at which point the Gatekeeper 102 can repeat the shutdown process.

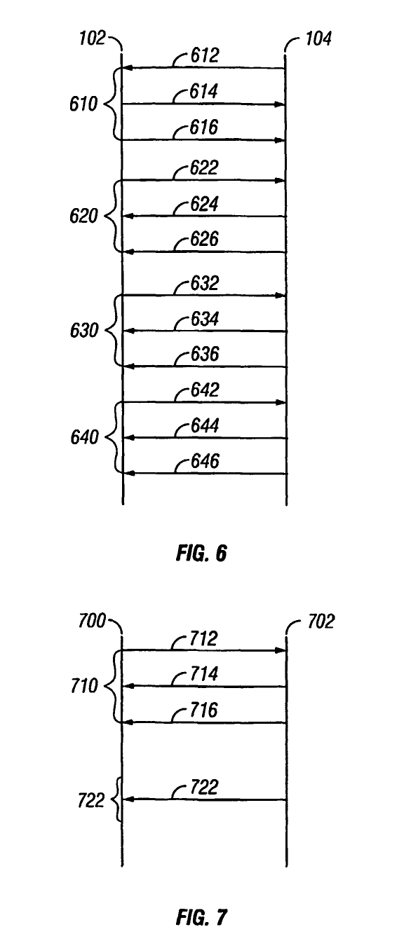

FIG. 6 shows a communications protocol between an Alert Dispatcher and a Gatekeeper of the Data Tracking and Management System in an embodiment of the invention. For protocol 610, the Alert Dispatcher 104 registers with the Gatekeeper 102 using a message 612. Upon successful processing of the message 612, the Gatekeeper 102 responds with an ACK 614, otherwise the Gatekeeper 102 responds with a NACK 616. If the NACK 616 is sent, the Alert Dispatcher 104 can elect to retransmit message 612. The ACK 614 can further comprise Alert Dispatcher configuration information, such as the no alert interval, which is the interval of time during which any alert received should be deferred until after the interval expires.

For Protocol 620, the Gatekeeper 102 sends status messages to the Alert Dispatcher 104 using a message 622. Upon successful processing of the message, the Alert Dispatcher 104 responds with an ACK 624, otherwise a NACK 626 is returned. Upon receipt of the ACK 624, the Gatekeeper 102 stores this event in an alert history log. If a NACK 626 is received, the Gatekeeper 102 can retransmit the status message 622.

For protocol 630, the Gatekeeper 102 requests the Alert Dispatcher 104 to shutdown, using a message 632. Upon successful processing of the message, the Alert Dispatcher 104 responds with an ACK 634. If unsuccessful, the Alert Dispatcher 104 responds with a NACK 636, at which the Gatekeeper 102 can repeat the shutdown process.

For protocol 640, the Gatekeeper 102 reconfigures the Alert Dispatcher 104 using a message 642, which comprises configuration parameters for the Alert Dispatcher 104, such as a no alert interval. Upon successful processing of the message, the Alert Dispatcher 104 responds with an ACK 644. If unsuccessful, the Alert Dispatcher 104 responds with a NACK 646, at which time the Gatekeeper 102 can retransmit the message 642.

FIG. 7 shows a communications protocol between an Agent and a Sub-Agent of the Data Tracking and Management System in an embodiment of the invention. For protocol 710, the Agent 700 configures a Sub-Agent 702 using a message 712, which comprises a configuration information for the Sub-Agent 702, such as IP address, ports to sniff packets, and/or login information used to poll log files. Upon successful processing of the message, the Sub-Agent 702 responds with an ACK 714. If unsuccessful, the Sub-Agent 702 responds with a NACK 716, which can further comprise a failure reason, at which the Agent 700 can retransmit message 712.

For protocol 720, the Sub-Agent 702 can submit to its responsible Agent 700 a message 722 that matches the validator of the Sub-Agent 702.

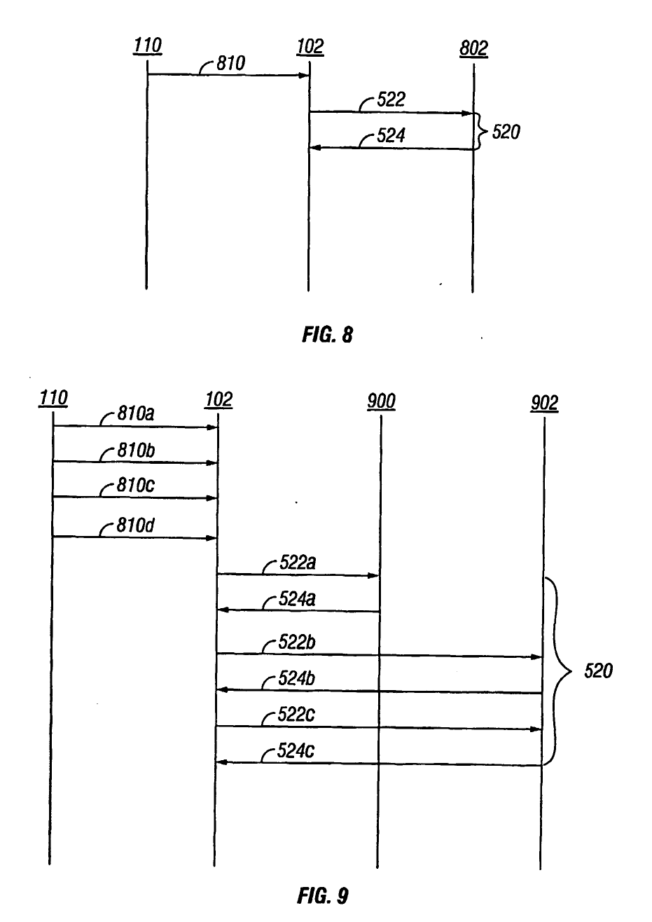

FIG. 8 shows a diagram illustrating a shutdown procedure for a Task Manager of the Data Tracking and Management System in an embodiment of the invention. As shown in FIG. 8, the Viewer 110 issues a command message 810 to the Gatekeeper 102 to shutdown Task Manager 400. In accordance with the protocol 520, the Gatekeeper 102 issues the message 522 to the responsible Key Master 802. The Key Master 802 then attempts to shutdown the Task Manager 400. The success of this action is reported back to the Gatekeeper 102 in the message 524, which comprises the ID number of the Task Manager 400 and the ID number of its responsible Key Manager 802.

FIG. 9 shows a diagram illustrating a shutdown procedure for a plurality of Task Managers of the data tracking and management system. In the embodiment shown in FIG. 9, a Key Master 900 is responsible for the Task Manager 400 of ID 1 and ID 2 and the Key Master 902 is responsible for the Task Manager 400 of ID 3 and ID 4. In this embodiment, the Viewer 110 issues requests to shutdown the Task Manager 400 of ID 1, ID 2, ID 3 and ID 4 with messages 810a, 810b, 810c and 810d. The messages 810a, 810b, 810c and 810d have the same types of fields as the message 810 mentioned above, but differ in their values. The Gatekeeper 102 accumulates these requests and using protocol 520 submits two shutdown request messages 522a and 522b for the Task Manager 400 to the Key Master 900 and the Key Master 902, respectively. In this example, if the Key Master 900 has successfully shutdown the Task Manager 400 of ID 1 and ID 2, then the return message 524a comprises an ACK for ID 1 and ID 2. Likewise, if the Key Master 902 has successfully shutdown the Task Manager 400 of ID 3 but not of ID 4, then the return message 524b comprises an ACK for ID 3 but a NACK for ID 4. Upon receiving the message 524b, the Gatekeeper 102 can again attempt to shutdown the Task Manager 400 of ID 4 by sending a request message 522c to the Key Master 902. If the Key Master 902 is successful in shutting down the Task Manager 400 of ID 4, then the return message 542c comprises an ACK for ID 4.

FIG. 10 shows a diagram illustrating a shutdown procedure for a Key Master of the Data Tracking and Management System in an embodiment of the invention. As shown in FIG. 10, the Viewer 110 sends message 1002 to the Gatekeeper 102 to request the shutdown of a Key Master 1000. The remaining transaction follows the protocol 530 as described above.

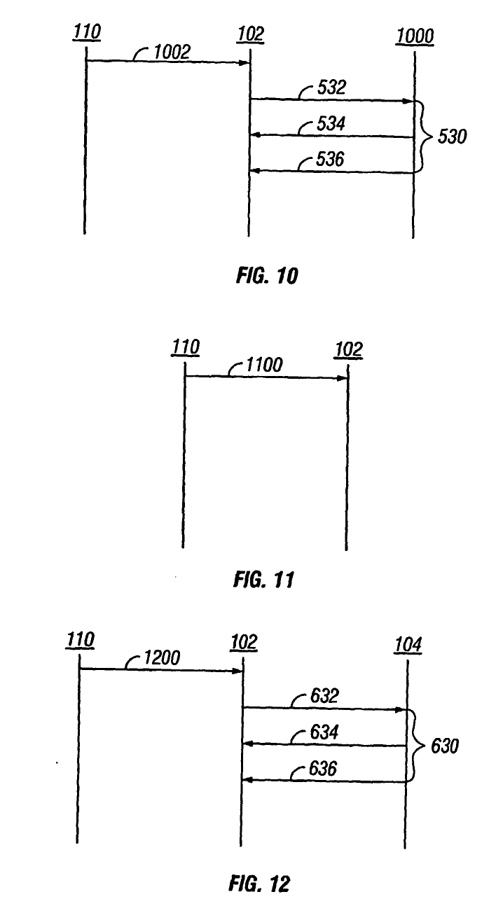

FIG. 11 shows a diagram illustrating a shutdown procedure for a Gatekeeper of the Data Tracking and Management System in an embodiment of the invention. In the embodiment shown in FIG. 11, the Viewer 110 requests the shutdown by issuing a command message 1100 to the Gatekeeper 102.

FIG. 12 shows a diagram illustrating a shutdown procedure for an Alert Dispatcher of the Data Tracking and Management System in an embodiment of the invention. In the embodiment shown in FIG. 12, the Viewer 110 sends a request message 1200 to the Gatekeeper 102. The remainder of the transaction then follows the protocol 630 as described above.

The systems and methods of the present invention may be embodied in other specific forms without departing from the teachings or essential characteristics of the invention. The described embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A system for tracking and managing data over a computer network including a plurality of application computers each operating an computer software application program, the system comprising:
a key master;
a system startup module connected to the key master;
a gatekeeper connected to the system startup module;
a task manager connected to the key master and the gatekeeper;
a central database connected to the gatekeeper;
a plurality of agents connected to the task manager;
each of a plurality of sub-agents independently connected to each of the plurality of agents and each of the plurality of application computers.
and an alert dispatcher connected to the system startup module and the gatekeeper.

2. The system of claim 1, wherein the alert dispatcher provides an alert comprising an email message.

3. The system of claim 1, wherein the alert dispatcher provides an alert comprising an electronic instant message.

4. The system of claim 1, wherein the alert dispatcher provides an alert comprising a paging message.

5. The system of claim 1, wherein the system uses a Linux operating system.

6. The system of claim 1, wherein the central database comprises a plurality of independent databases.

7. A method for tracking and managing a message over a computer network including a plurality of application computers each operating an computer software application program, the method comprising the steps of:
monitoring the message at a lowest common format;
comparing the content of the message to a validator key;
extracting a message key if the content of the message matches the validator key;
assembling the message based on one or more predetermined criteria;
queuing the message;
retrieving the message; and
storing the message.

8. The method of claim 7, wherein the method further comprises the step of alerting an operator with an alert notification of a shutdown of the one of the plurality of application computers.

9. The method of claim 8, wherein the alert comprises an email message.

10. The method of claim 8, wherein the alert comprises an electronic instant message.

11. The method of claim 8, wherein the alert comprises a paging message.

12. The method of claim 7, wherein the method further comprises the steps of:
retrieving the message; and
viewing the message.

13. The method of claim 7, wherein the lowest common format comprises TCP/IP, FTP, or SNA.

14. A method for tracking and managing a message over a computer network including a plurality of application computers each operating an computer software application program, the method comprising the steps of:
monitoring the message at a lowest common format with a sub-agent;
comparing the content of the message to a validator key with the sub-agent;
extracting a message key if the message matches the validator key with an agent;
assembling the message based on one or more predetermined rules;
queuing the message;
retrieving the message with a task manager; and
storing the message in a central database.

15. The method of claim 14, wherein the method further comprises the step of alerting an operator with an alert of a shutdown of the one of the plurality of application computers.

16. The method of claim 15, wherein the alert comprises an email message.

17. The method of claim 15, wherein the alert comprises an electronic instant message.

18. The method of claim 15, wherein the alert comprises a paging message.

19. The system of claim 14, wherein the central database comprises a plurality of independent databases.

20. The method of claim 14, wherein the method further comprises the step of retrieving and analyzing the message.

21. The method of claim 14, wherein the lowest common format comprises TCP/IP, FTP, or SNA.
